(19) United States
(12) Patent Application Publication
(10) Pub. No.: US 2018/0152069 A1
(43) Pub. Date: May 31, 2018

(54) PRE-FORMED COIL, WINDING STRUCTURE, AND STATOR FOR A GENERATOR OF A WIND TURBINE AND METHOD FOR PRODUCING A STATOR

(71) Applicant: Wobben Properties GmbH, Aurich (DE)

(72) Inventors: Jochen RÖER, Ganderkesee (DE); Sven WOLLGAM, Jade (DE)

(21) Appl. No.: 15/580,535

(22) PCT Filed: May 26, 2016
(86) PCT No.: PCT/EP2016/061917

§ 371 Date: Dec. 7, 2017

(30) Foreign Application Priority Data
Jun. 19, 2015 (DE) 10 2015 211 355.8

(51) Int. Cl. H02K 3/28; H02K 3/12; H02K 3/30; H02K 3/02; H02K 15/06; H02K 15/00; H02K 15/12

(52) U.S. Cl. CPC H02K 3/28; H02K 3/12; H02K 3/30; H02K 2203/06; H02K 15/065; H02K 15/0056; H02K 15/12; H02K 3/02

(57) ABSTRACT

A form-wound coil of a stator of a generator of a gearless wind power installation is provided. The form-wound coil includes an electrical conductor with a first and a second terminal. The terminals are used serve in each case for electrical connection to a further form-wound coil. The terminals in each case have a thread for electrical connection using a screw. A winding structure, a stator having the form-wound coil, and a method for producing the stator are also provided.

### BACKGROUND

### Technical Field

The invention relates to a form-wound coil of a stator of a generator of a gearless wind power installation. The invention also relates to a winding structure of a stator of a generator of a wind power installation, and to a stator. The invention also relates to a method for producing a stator.

### Description of the Related Art

Stators of generators of gearless wind power installations are known which have multiple strands with in each case multiple windings. Said windings are produced with an insulated wire, composed for example of copper. For this purpose, the wire of a strand is wound into the grooves of the stator, such that a strand is produced from one continuous piece of the wire. This winding of the stator is highly cumbersome and must expediently be performed by hand in order—in particular at the bend points—to monitor the integrity of the wires and also the insulation of the wire already during the winding process.

Furthermore, form-wound coils are known which correspond to prefabricated windings of a conductive material and which are inserted directly into the grooves of a stator. The form-wound coils have terminals which project far beyond the stator groove and by means of which the individual form-wound coils are interconnected by soldering or welding such that the desired electrical interconnection of the winding structure as a whole is realized.

Owing to the high level of heat generation during the soldering process, the terminals must be situated at a great distance from the groove in order that the form-wound coil does not become too hot in the region of the groove and thus lead to damage to the stator, in particular damage to an insulation with respect to the stator. Such stators therefore have a particularly great axial depth.

The German Patent and Trade Mark Office has, in the priority-founding German patent application, researched the following documents: Schmidt, W. et al.: “Umweltverträgliche Harzimprägnierung elektrischer Maschinen mittels Stromwärme” [“Environmentally Compatible Resin Impregnation of Electric Machines Using Current Heat”], Tzscheutschler, R. et al.: “Technologie des Elektromaschinenbaus” [“Electrical Engineering Technology”], Heilles, Franz: “Wicklungen elektrischer Maschinen” [“Windings of Electric Machines”] and Wiedemann, E. et al.: “Konstruktion elektrischer Maschinen” [“Construction of Electric Machines”].

### BRIEF SUMMARY

Provided is a method that is less cumbersome than the method of winding the stator with continuous strands, but which at the same time may not require an excessive depth of a stator, as is known in the prior art.

A form-wound coil of a stator of a generator of a gearless wind power installation is proposed which has an electrical conductor with a first and with a second terminal. The terminals serve for electrical connection to a further form-wound coil. Furthermore, the terminals in each case have a thread for producing the electrical connections by means of screw connection. In one embodiment of the terminals, said terminals are formed as round parts.

It is thus possible for a stator of a generator of a gearless wind power installation to be manufactured by virtue of the individual form-wound coils being inserted into the grooves of the stator and the electrical connections of the individual form-wound coils being produced by means of screw connections. A generation of heat by soldering or welding, on the complete generator, during the production of the electrical connections can thus be avoided.

It is thus possible for the terminals to be arranged much closer together on the stator body without the risk of damage to the stator, in particular to an insulation. Thus, a stator can be realized which has a much smaller axial depth. Furthermore, the stator can be produced by means of simple insertion of the form-wound coils, without the need for cumbersome winding of the windings.

The generator is preferably in the form of a ring generator. Accordingly, the magnetically active regions of the rotor and of the stator, specifically in particular the laminated cores of the stator and of the rotor, are arranged in a ring-shaped region around the air gap that separates the rotor and stator. Here, the generator is free from magnetically active regions in an inner region with a radius of at least 50% of the mean air gap radius.

A ring generator can also be defined as being one in which the radial thickness of the magnetically active parts or—in other words—of the magnetically active region, specifically the radial thickness from the inner edge of the pole wheel to the outer edge of the stator, or from the inner edge of the stator to the outer edge of the rotor, in the case of an external-rotor machine, is smaller than the air gap radius, in particular in which the radial thickness of the magnetically active region of the generator amounts to less than 30%, in particular less than 25%, of the air gap radius. In addition, or alternatively, a ring generator may be defined as being one in which the depth, specifically the axial extent of the generator, is smaller than the air gap radius, in particular in which the depth amounts to less than 30%, in particular less than 25%, of the air gap radius. In addition, or alternatively, a ring generator is of four-pole configuration, and specifically has at least 48, 96, in particular at least 192 rotor poles.

In a further embodiment, the thread of the terminals is an internal thread. An internal thread is advantageous because the electrical connections of the form-wound coils can be produced by means of conventional screws with external thread. Furthermore, an internal thread is better protected against external influences than an external thread.

In a further embodiment, at least one of the terminals of the form-wound coil is angled in relation to a coil longitudinal axis or in relation to a line parallel to the coil longitudinal axis. Furthermore, the other terminal is not angled in relation to a coil longitudinal axis or in relation to a line parallel to the coil longitudinal axis. That is to say, the two terminals have a different angle in relation to a coil longitudinal axis or in relation to a line parallel to the coil longitudinal axis, which angle, in one preferred embodiment, lies in the range from 45 to 90°, particularly preferably in the range from 60 to 80°.

In one embodiment, a form-wound coil has two substantially parallel elongate limbs, wherein each limb has a length of at least 80 centimeters (cm), at least 100 cm or at least 120 cm. Furthermore, this embodiment of the form-wound coil comprises a first end, at which the limbs are interconnected, and a second end, at which the terminals of the form-wound coil are provided.

Since two limbs of different form-wound coils are provided in each groove of the stator, the terminals of the form-wound coils are, after being arranged in the stator, situated very close together. Owing to the angling of at least one of the terminals in relation to the other terminal, however, an electrical connection to the terminals can be produced easily, because these are thus easily accessible. An electrical connection of the form-wound coils can thus be produced easily, and furthermore, the risk of a short circuit of two touching terminals is counteracted.

In a further embodiment, the conductor has multiple layers, in particular two layers. Said multiple layers are in each case connected to a terminal. In a particularly preferred form, each layer is formed with a copper flat bar, a copper strip or a copper flat wire. A copper flat wire which has a rectangular cross section and a height of 0.8 to 1 cm and a width of 1 to 2 cm is preferred. The multiple layers of the conductor are then arranged or stacked one above the other such that the layers point with one of their relatively wide sides toward one another.

In a further embodiment, the form-wound coil has multiple windings of the conductor. In a particularly preferred embodiment, the form-wound coil comprises four windings.

In a further embodiment, the form-wound coil assumes at least three different forms, wherein the terminals of the different forms are at different distances from a geometrical central point of the form-wound coil. During the later insertion of the form-wound coils into the stator grooves, a connection of the form-wound coils is thus easily possible, because adjacent first terminals have different heights and adjacent second terminals likewise have different heights and are thus easily accessible for the production of the electrical connections.

A conductor with a single layer may be twice as thick in relation to a conductor with two layers in order to achieve the same electrical characteristics as the conductor with two layers. The use of a relatively flat copper flat wire is therefore advantageous for producing the form-wound coil in multiple layers as a conductor with multiple windings, because it is relatively easy to bend. A form-wound coil with multiple windings is thus particularly easy to produce.

In a further embodiment, the conductor or each layer of the conductor of the form-wound coil is insulated. In a particularly preferred embodiment, said insulation is an insulation by means of lacquer and/or powder coating. Insulation of the form-wound coil is thus possible already before the production of the form-wound coil through simple application of the insulating layer, for example of an insulating lacquer, to the conductor in the unformed state, such that a reliable insulation is easy to produce.

Said insulation serves—in addition to a groove insulation inserted into the grooves later, for insulating the form-wound coil in relation to the likewise conductive stator material. Thus, a complete enwinding of the form-wound coil for insulating purposes, also referred to as insulating winding, before the insertion of the form-wound coils into the stator grooves, can be omitted. An insulation winding of the form-wound coils is disadvantageous because the insulating winding impedes the heat dissipation from the form-wound coil during operation. Accordingly, a form-wound coil without an enwinding for insulation purposes, as per the present exemplary embodiment, is advantageous with regard to its heat dissipation.

In a further embodiment, the terminals are connected to the conductor by means of soldering or welding. The connection of the conductor to the terminals, which have the thread, is particularly advantageously produced by induction welding.

By soldering or welding of the terminals to the conductor, a particularly low transition resistance of the connecting point is achieved. Soldering or welding of the terminals to the conductor is also possible as long as the form-wound coil is not yet inserted into the stator, because the generation of heat during the soldering or welding cannot damage the stator.

In a further embodiment, the conductor, in the region of the connection to at least one terminal, has an insulation composed of glass-fiber-reinforced plastic. Said plastic serves for insulating at least a part of the conductor and/or a part of the terminal.

A form-wound coil whose conductor is insulated for example by means of lacquer or powder coating may, for the soldering or welding of the terminal, have the insulation removed in the region of the soldering or welding point. This is realized for example by virtue of the insulation being burned off in said region. Since the risk of a short circuit in adjacent connecting regions of adjacent conductors with their terminals exists, as a result of the removal of the insulation, after the arrangement of the form-wound coils in the grooves of the stator, the glass-fiber-reinforced plastic prevents such a short circuit.

In a further embodiment, the form-wound coil, in the region of the terminal, has a spacer which prevents adjacent terminals from touching as a result of vibrations of the stator during the operation of the stator, which could result in a short circuit. In these exemplary embodiments, therefore, short circuits are counteracted.

In a further embodiment, the conductor and the terminals of the form-wound coil are manufactured with copper or a copper alloy. Copper or a copper alloy advantageously have a low resistance, such that as great an amount of electrical energy as possible and as low an amount of thermal energy as possible are generated by the generator.

Furthermore, provided is a winding structure of a stator of a generator of a wind power installation. A winding structure corresponds to the entirety of the form-wound coils with their connections which are used in the stator of a generator of a wind power installation. The winding structure comprises multiple form-wound coils, in particular according to one of the preceding embodiments. The form-wound coils each have an electrical conductor with a first and a second terminal. The terminals each comprise a thread. Furthermore, the winding structure comprises multiple connecting elements in each case for the electrical connection of two terminals of two form-wound coils by means of screw connections. The connecting elements may also be referred to as connecting lugs.

By means of the thread, therefore, a winding structure for a stator can be realized which has a much smaller depth than a winding structure for a stator with conventional form-wound coils. Furthermore, the stator can be produced by simple insertion of the form-wound coils without the need for cumbersome winding of the windings to be performed.

In a further embodiment, multiple form-wound coils are connected, or interconnected, in series, and thus form a strand of the winding structure.

In a further embodiment of the winding structure, the form-wound coils are interconnected such that the winding structure is of six-phase configuration. This means that the form-wound coils are interconnected such that six strands are provided. Here, a first and a second strand are assigned to a first phase, a third and a fourth strand are assigned to a second phase, and a fifth and a sixth strand are assigned to a third phase.

Furthermore, in a further embodiment, the winding structure is divided into multiple, in particular 2, 4, 6 or 8, sections or segments which are connected in parallel. Each segment then comprises, for example, six phases, wherein identical phases of the segments are connected in parallel in the winding structure. This results in a reduction of the maximum voltage induced in the strands, in a manner dependent on the number of segments.

In an embodiment of the winding structure, the terminals of two form-wound coils are connected by means of connecting elements. The connecting elements comprise a conductive connector, in particular a copper flat bar or a copper strip, which has two apertures at its outer ends. In a further embodiment, the ends are slightly angled. The apertures are produced for example by drilling. Furthermore, the connecting element comprises two screws, which are produced in particular with brass.

Accordingly, the conductive connector with its apertures, that is to say for example drilled holes, is positioned in front of the threads of the two terminals of two different form-wound coils, and the screws are led through the apertures and screwed into the thread of the terminal. An electrical connection with low transition resistance can thus be produced.

In a further embodiment of the winding structure, the connecting elements and the form-wound coils have a substantially identical coefficient of thermal expansion. It is ensured in this way that, despite the heat generated during the operation of the winding structure, the screw connections remain secure.

In a further embodiment of the winding structure, the conductive connectors have a U shape. The form-wound coils are configured in multiple, in particular three, different forms. Different forms of the form-wound coils have different lengths of terminal regions, in particular three different lengths of in each case both terminals. Therefore, the connecting elements are arranged in groups, in particular in groups of three. In a particularly preferred embodiment, the ends of the same side of U-shaped conductive connectors of one group are then arranged, or connected to the form-wound coils, between the ends of the two sides of U-shaped conductive connectors of another group. Thus, the openings of the “U” s of the conductive connectors of successive groups point alternately in the circumferential direction toward the center of the generator or away from the center. This applies on the one hand to the conductive connectors of the first terminals of the form-wound coil and on the other hand also to the conductive connectors of the second terminals of the form-wound coil.

The stator can thus be realized with an even smaller space requirement in an axial direction.

Furthermore, provided is a stator of a generator of a wind power installation. The stator comprises multiple encircling grooves, wherein respectively adjacent grooves have a substantially equal spacing. Form-wound coils according to one of the preceding embodiments are inserted into the grooves.

By means of the interconnection of the form-wound coils by means of the terminals, for example soldered-on round pieces, and the screw connection to the connecting elements, for example connecting lugs, a relatively short construction in the region of the winding heads is possible in relation to an interconnection using switch rings.

In one embodiment, the stator is formed with form-wound coils and a winding structure according to one of the preceding embodiments.

Furthermore, a method for producing a stator according to one of the preceding embodiments is provided. For the production process, the form-wound coils are inserted, beginning from an arbitrary first groove, by virtue of a predetermined number of form-wound coils to be inserted firstly being inserted only partially into the grooves or being positioned in front of the grooves, and being inserted into the corresponding grooves fully only together with a predetermined number of the form-wound coils to be inserted last.

As has already been discussed above, the limbs of two different form-wound coils are inserted into one groove. As a result, as viewed in the circumferential direction of the stator, between the two limbs of one and the same form-wound coil, there are inserted the limbs of multiple other form-wound coils. Accordingly, the form-wound coils thus overlap in the state in which they have been inserted into the stator.

As a result of this overlap, it is normally the case that a form-wound coil that has been inserted into the stator grooves first is partially bent out of the groove again for the insertion of the form-wound coils that are to be inserted last. By means of the production method, this bending-out is now no longer necessary, such that no damage to the insulation of the form-wound coils, or bending of the form-wound coils out of shape, occurs.

In a further embodiment of the method, the form-wound coils have in each case two terminals with in each case one thread. Two terminals of different form-wound coils are then connected in each case by means of a copper flat bar or a copper strip which has two apertures, wherein, for this purpose, two screws are screwed through the apertures into the thread of the terminals of the form-wound coils, in particular with a predetermined torque. A secure electrical connection of the form-wound coils is realized by means of said screw connection.

In a further embodiment of the method, the terminals and the copper flat bar or the copper strip are ground and/or polished in the region of their contact surfaces before the connection is produced. In a further embodiment, the connection is produced at the latest two hours after the grinding and/or polishing.

Corrosion of the copper parts is thus avoided because, after the connection, no further oxygen reaches the interconnected copper parts. Thus, an electrical connection with a particularly low electrical resistance is ensured.

In a further embodiment of the method, the completed stator is fully immersed into a resin bath or a liquid resin and is removed from the resin again in order to allow the resin adhering to the stator to cure.

In this way, an insulation of all conductive parts which are not already insulated is realized. Furthermore, the stability of the entire structure is thus increased.

### BRIEF DESCRIPTION OF THE SEVERAL VIEWS OF THE DRAWINGS

Further embodiments of the invention will emerge from the exemplary embodiments discussed in more detail on the basis of the drawings. In the drawing:

FIG. 1 shows a wind power installation,

FIG. 2 shows a schematic side view of a generator,

FIG. 3 shows a first view of a form-wound coil,

FIG. 4 shows a further view of a form-wound coil,

FIG. 5 shows a detail of a perspective view of a stator,

FIG. 6 shows a stator with six inserted form-wound coils,

FIG. 7 shows a plan view of an exemplary embodiment of a generator,

FIG. 8 shows a view, from the center of the stator, of the form-wound coils inserted into a stator, and

FIG. 9 shows a further perspective view of a stator.

### DETAILED DESCRIPTION

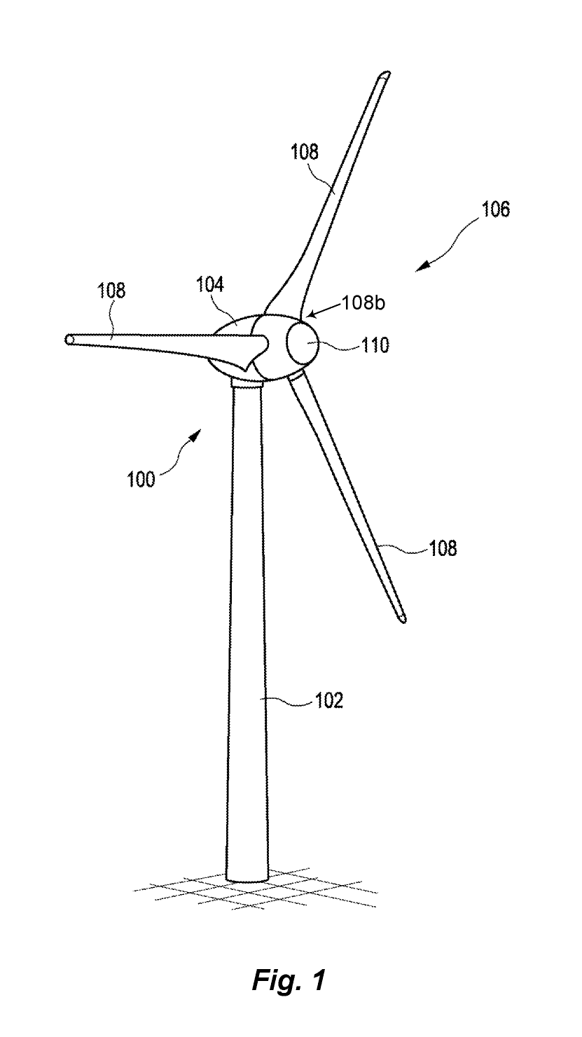

FIG. 1 is a schematic illustration of a wind power installation. The wind power installation 100 has a tower 102 and a nacelle 104 on the tower 102. On the nacelle 104 there is provided an aerodynamic rotor 106 with three rotor blades 108 and a spinner 110. During the operation of the wind power installation, the aerodynamic rotor 106 is set in a rotational movement by the wind and thus also rotates a rotor of a generator, which is coupled directly or indirectly to the aerodynamic rotor 106. The electrical generator is arranged in the nacelle 104 and generates electrical energy. The pitch angles of the rotor blades 108 can be varied by means of pitch motors at the rotor blade roots 108b of the respective rotor blades 108.

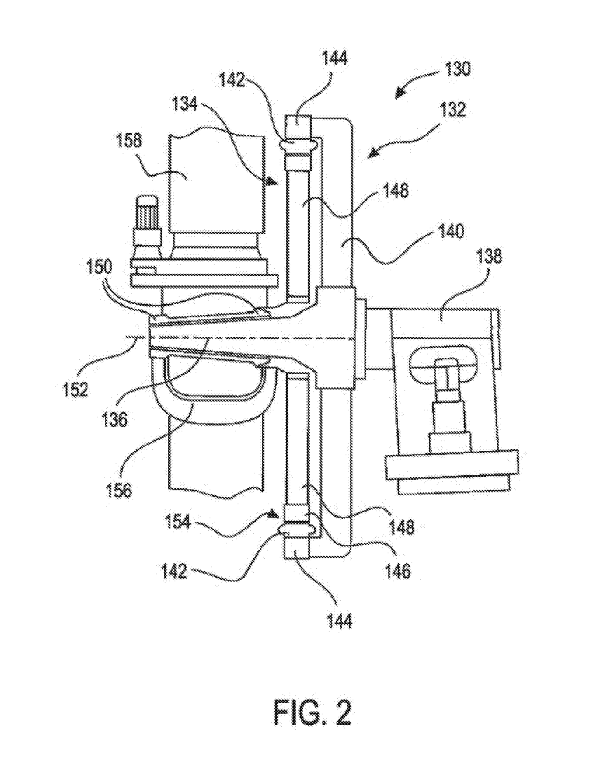

FIG. 2 shows a generator 130 schematically in a side view. Said generator has a stator 132 and an electrodynamic rotor 134 mounted so as to be rotatable relative to said stator, and is fastened with its stator 132 to a machine support 138 by means of a journal 136. The stator 132 has a stator support 140 and stator laminated cores 142, which form stator poles of the generator 130 and which are fastened by means of a stator ring 144 to the stator support 140.

The electrodynamic rotor 134 has rotor pole shoes 146, which form rotor poles and which, by means of a rotor support 148 and bearing 150, are mounted on the journal 136 so as to be rotatable about the axis of rotation 152. The stator laminated cores 142 and rotor pole shoes 146 are separated by only a narrow air gap 154, which is a few mm thick, in particular less than 6 mm, but has a diameter of several meters, in particular more than 4 m.

The stator laminated cores 142 and the rotor pole shoes 146 form in each case one ring and, together, are also ring-shaped, such that the generator 130 is a ring generator. The electrodynamic rotor 134 of the generator 130 intentionally rotates together with the rotor hub 156 of the aerodynamic rotor, of which roots of rotor blades 158 are indicated.

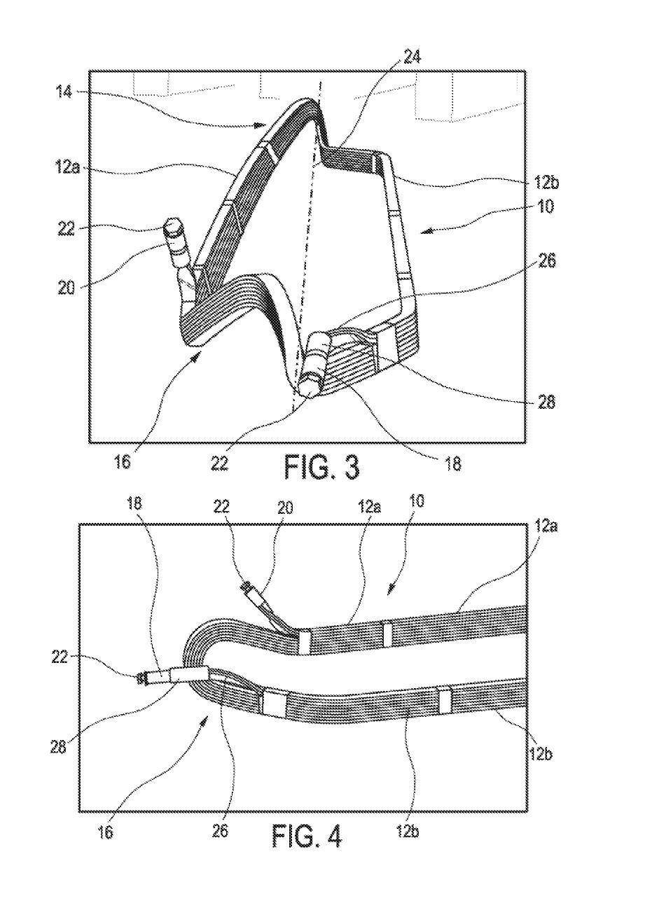

FIG. 3 shows a view of an exemplary embodiment of a form-wound coil 10. The form-wound coil 10 has two limbs 12a, 12b. The limbs 12a, 12b run parallel to one another and have a length of greater than 90 cm. The two limbs 12a, 12b are interconnected at a first end 14 and at a second end 16.

The second end 16 of the form-wound coil 10 has a first terminal 18 and a second terminal 20. The terminals 18, 20 have an internal thread. Screws 22 are screwed into the internal thread of the terminals 18, 20. In relation to a coil longitudinal axis 24 or a line parallel to the coil longitudinal axis 24, the second terminal 20 is angled, and the first terminal 18 is not angled.

The form-wound coil 10 comprises a conductor 26 and the terminals 18 and 20, which are manufactured with copper. Furthermore, the screws 22 are manufactured with brass. The conductor 26 is composed of two layers of a flat wire, which are formed into four windings. That is to say, two layers of the flat wire, which is also referred to as copper flat wire, are connected to the two terminals 18, 20.

The form-wound coil 10 is thus formed with said two layers and four windings such that eight layers of the copper flat wire are arranged or stacked one above the other in the region of the limbs 12a, 12b and in the region of the first end 14.

Owing to the led-out terminals 18, 20, six layers remain arranged one above the other in the region of the second end 16. The copper flat wire is insulated by lacquering. In the connecting region of the conductor 26 to the terminals 18, 20, however, the insulation has been removed in order to connect the terminals 18, 20 to the conductor 26 by induction welding. In the region of the connection of the first terminal 18 to the conductor 26, a glass-fiber-reinforced plastic 28 is applied in order to re-insulate said part, which has had the insulation of the conductor 26 removed.

In an exemplary embodiment which is not illustrated, such a glass-fiber-reinforced plastic is also provided in the connecting part between the second terminal 20 and the conductor 26. In order that the form-wound coil 10 maintains its shape, the layers of the form-wound coil have been enwound in narrow regions. An insulation winding is however not provided.

FIG. 4 shows a further view of the form-wound coil 10, wherein here, the second end 16 with a part of the limbs 12a, 12b is illustrated from the side. The exemplary embodiment of the form-wound coil illustrated in FIG. 4 corresponds to the exemplary embodiment of the form-wound coil in FIG. 3.

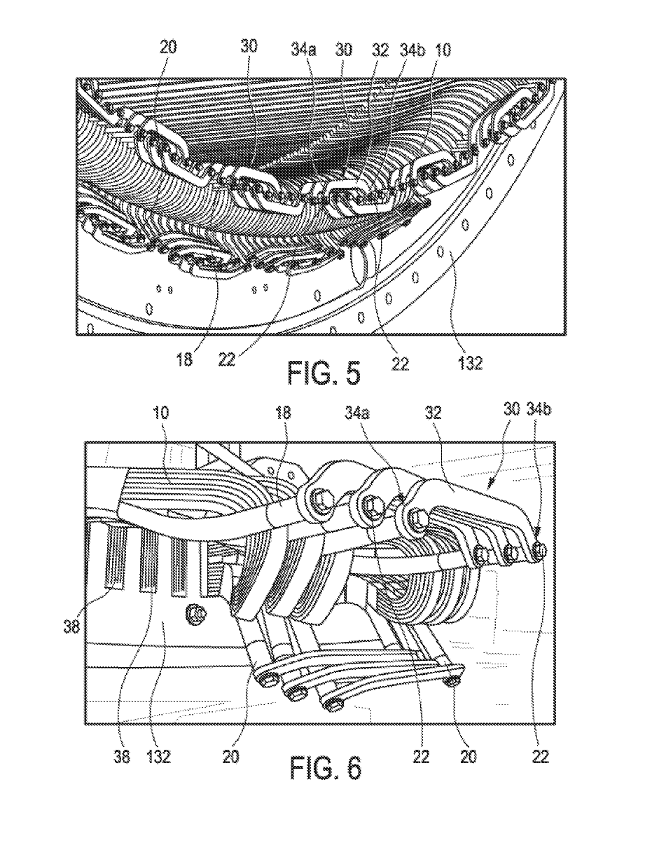

FIG. 5 shows a perspective view of a stator 132 of a generator 130 of a wind power installation 100 with form-wound coils 10. The form-wound coils 10 have in each case one first terminal 18 and one second terminal 20. The first terminals 18 of the form-wound coils 10 are connected in each case to first terminals 18 of other form-wound coils 10. The same applies to the second terminals 20 of the form-wound coils 10.

The connections are produced by means of connecting elements 30. The connecting elements 30 may also be referred to as connecting lugs. The connecting elements 30 comprise in each case one flat bar 32, which has in each case one aperture at its end 34a, 34b. Said apertures are not visible in the illustration because screws 22 have been screwed through the apertures into the terminals 18, 20. The flat bars 32 have a U shape, such that every sixth first terminal 18 and every sixth second terminal 20 is connected by means of a connecting element 30 of said type, without the connecting element 30 being in contact with other terminals 18, 20 which are not intended to be connected to one another. The connecting elements 30 are therefore not insulated.

It can also be seen that the connecting elements 30 are arranged in different planes. This is possible because the terminals 18, 20 of adjacent form-wound coils 10 project to different extents.

The connecting elements 30 that are connected to the second terminals 20 have apertures which are spaced further apart from one another than the apertures of the connecting elements 30 connected to the first terminal 18. This is because—proceeding from a center of the stator 132—the second terminals 20 lie on a greater radius than the first terminals 18.

Furthermore, the flat bars 32 of the connecting elements 30 are of cranked or slightly angled form in order that the screws 22 can engage cleanly into the threads of the second terminals 20.

FIG. 6 shows an exemplary structure of a stator 132, into the grooves 38 of which six form-wound coils 10 are inserted. The form-wound coils 10 are connected to one another by means of connecting elements 30. Here, it is pointed out that the electrical connection is produced merely for the purposes of testing the production of the screw connection. The interconnection of the coils during later use differs from the connection configuration illustrated, and is accordingly merely exemplary. Specifically, the interconnection configuration illustrated in FIG. 6 involves a self-contained strand, that is to say a short circuit. Specifically, all twelve terminals of the six coils are connected to one another.

In the left-hand region of the figure, the laminated form of the stator 132 can also be seen in the grooves 38 not occupied by form-wound coils 10.

FIG. 7 is an illustration similar to FIG. 5, with a detail now being shown on an enlarged scale. Again, the form-wound coils 10 can be seen, which have in each case one first terminal 18 and one second terminal 20. The first terminals 18 have a spacer 40. The spacer 40 for the prevention of short circuits, specifically in order that adjacent first terminals 18 do not come into contact as a result of vibrations.

It can also be seen that adjacent form-wound coils have terminals 18, 20 that project to different extents. This yields a sawtooth-like profile of the heights of the terminals 18, 20. In the exemplary embodiment illustrated, the connecting elements 30 have, in addition to the flat bar 32 and the screws 22, disks 42 which improve the distribution of the force of the screw 22 into the flat bar 32 when said screw is screwed into the thread of the terminals 18, 20. Accordingly, a connecting element 30 according to a preferred exemplary embodiment has a flat bar 32, two screws 22 and two disks 42.

The spacers 40 correspond to a plastics strip with multiple bores through which multiple terminals 18, 20 are led in a spaced-apart manner before the connecting elements 30 are attached. Furthermore, a bundle of data lines 44 is illustrated, by means of which temperature sensors, for example, are connected to an evaluation devices.

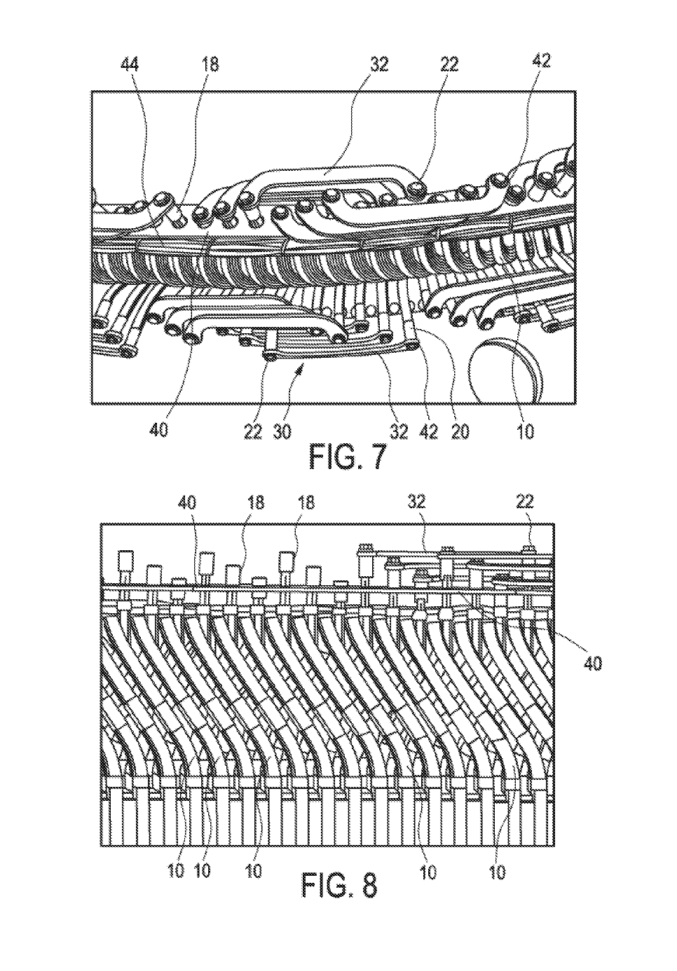

FIG. 8 shows a side view, from the center of the stator, of the form-wound coils 10. Here, the abovementioned sawtooth-like profile of the terminals 18, 20, in this case of the first terminals 18, can be seen particularly clearly. In the left-hand half of the figure, it is possible to see first terminals 18 which are not connected to other terminals 18 by means of connecting elements 30. Said terminals 18 accordingly serve as terminals for connection to generator terminals (not illustrated).

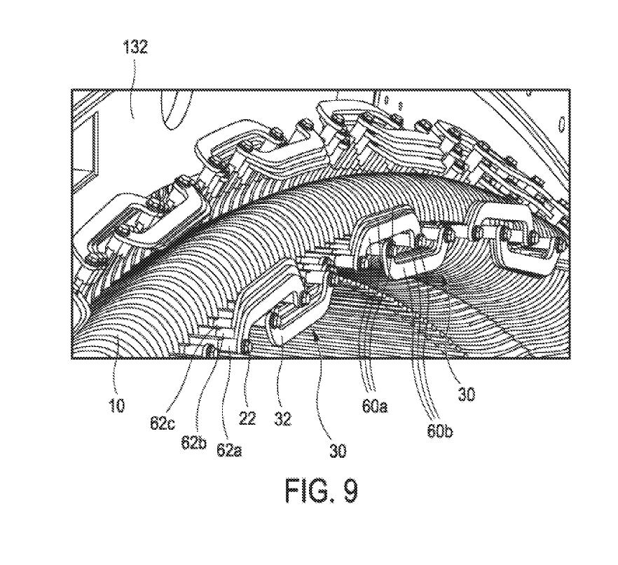

FIG. 9 shows a further perspective view of a stator 132. Identical reference designations are used to denote identical features. FIG. 9 illustrates the arrangement of the connecting elements 30 in groups 60a, 60b. The conductive connectors 32 of the connecting elements 30 have a U shape, and the form-wound coils 10 are provided in three different forms with three different lengths of terminal regions 62a to 62c, such that the connecting elements 30 are arranged in groups of three 60a, 60b.

The ends of the same side of U-shaped conductive connectors 32 of one group 60b are arranged between the ends of both sides of U-shaped conductive connectors 32 of another group 60a. The stator can thus be realized with a particularly small space requirement in an axial direction.

1. A form-wound coil of a stator of a generator of a gearless wind power installation, comprising
an electrical conductor including:
a first terminal having a first thread for receiving a first screw and making an electrical connection to a respective further form-wound coil, and
a second terminal having a second thread for receiving a second screw and making an electrical connection to a respective further form-wound coil.

2. The form-wound coil as claimed in claim 1, wherein the generator is a ring generator.

3. The form-wound coil as claimed in claim 1, wherein the first and second threads are internal threads.

4. The form-wound coil as claimed in claim 1, wherein at least one of:
at least one of the first and second terminals of the form-wound coil is angled in relation to a coil longitudinal axis or in relation to a line parallel to the coil longitudinal axis, or
at least another terminal of the first and second terminals is not angled in relation to the coil longitudinal axis or in relation to the line parallel to the coil longitudinal axis.

5. The form-wound coil as claimed in claim 1, wherein the electrical conductor has at least two layers and the at least two layers are each connected to each terminal, and the electrical conductor is a copper flat bar, a copper strip or a copper flat wire.

6. The form-wound coil as claimed in claim 1, wherein the electrical conductor of the form-wound coil has at least four windings.

7. The form-wound coil as claimed in claim 1, wherein the form-wound coil has one of at least three different forms, wherein the terminals of the at least three different forms are at different distances from a geometrical central point of the form-wound coil.

8. The form-wound coil as claimed in claim 1, wherein the electrical conductor or each layer of the electrical conductor of the form-wound coil is insulated using at least one of: lacquer, or powder coating.

9. The form-wound coil as claimed in claim 1, wherein the terminals are each soldered or welded to the electrical conductor.

10. The form-wound coil as claimed in claim 1, wherein the electrical conductor, in the region of connection to at least one terminal, has an insulation composed of glass-fiber-reinforced plastic for insulating at least one of: at least a part of the electrical conductor, or a part of the terminal, and the at least one terminals has spacers.

11. The form-wound coil as claimed in claim 1, wherein the electrical conductor and the first and second terminals are copper or copper alloy.

12. A winding structure of a stator of a generator of a wind power installation, comprising:
a plurality of form-wound coils, wherein each form-wound coil of the plurality form-wound coils includes:
an electrical conductor including:
a first terminal having a first thread for receiving a first screw and making an electrical connection to a respective further form-wound coil, and
a second terminal having a second thread for receiving a second screw and making an electrical connection to a respective further form-wound coil, wherein the winding structure includes a plurality of connecting elements, each connecting element being operative to electrically connect two terminals of two form-wound coils of the plurality of form-wound coils using screw connections.

13. The winding structure as claimed in claim 12, wherein the plurality of form-wound coils are interconnected such that the winding structure has a six phase configuration, wherein a first and a second strand are assigned to a first phase, a third and a fourth strand are assigned to a second phase, and a fifth and a sixth strand are assigned to a third phase.

14. The winding structure as claimed in claim 12, wherein the winding structure is divided into multiple segments, and identical phases of each segment are connected in parallel with one another.

15. The winding structure as claimed in claim 12, wherein a connecting element of the plurality of connecting elements includes one conductive connector having two apertures and two screws.

16. The winding structure as claimed in claim 12, wherein the plurality of connecting elements and the plurality of form-wound coils have a substantially identical coefficients of thermal expansion.

17. The winding structure as claimed in claim 15, wherein the conductive connector of the connecting elements has a U shape, and the form-wound coil has one of multiple different forms, wherein the different forms provide different lengths of terminal regions such that the plurality of connecting elements are arranged in groups.

18. The winding structure as claimed in claim 17, wherein the ends of the same side of U-shaped conductive connectors of one group are arranged, or connected to the form-wound coils, between the ends of the two sides of U-shaped conductive connectors of another group.

19. A stator of a generator of a wind power installation, comprising:
a plurality of encircling grooves, wherein
respectively adjacent grooves of the plurality of encircling grooves have a substantially equal spacing with one another, and
the plurality of form-wound coils as claimed in claim 1, wherein the plurality of form-wound coils are inserted into the plurality of grooves.

20. (canceled)

21. A method for making a stator, comprising:
inserting adjacent form-wound coils successively into grooves of the stator by at least:
inserting a first predetermined number of the form-wound coils only partially into corresponding grooves or positioning the first predetermined number of the form-wound coils in front of the corresponding grooves, and
inserting the first predetermined number of the form-wound coils into the corresponding grooves fully only together with a second predetermined number of the form-wound coils to be inserted last.

22. The method as claimed in claim 21, wherein a form-wound coil of the form-wound coils including two terminals each having one thread, and two terminals of different form-wound coils are connected using a conductive connector having two apertures, wherein, two screws are screwed through respective apertures into respective threads of the two terminals.

23. The method as claimed in claim 21, comprising:
at least one of: grounding the two terminals and the conductive connector, or polishing the two terminals in a region of their contact surfaces before being connected by the conductive connector.

24. The method as claimed in claim 21, comprising:
immersing the stator fully into a resin bath or liquid resin, and
removing the stator from the resin bath or the liquid resin to allow resin adhering to the stator to cure.
